(19) United States
(12) Patent Application Publication
(10) Pub. No.: US 2002/0070504 A1
(43) Pub. Date: Jun. 13, 2002

(54) Track roller bearing as sealed structural unit

(75) Inventors: Frank Neubert, Schonungen (DE); Wilhelm Sebald, Bad Konigshofen (DE)

Correspondence Address: OSTROLENK FABER GERB & SOFFEN, 1180 AVENUE OF THE AMERICAS, NEW YORK, NY, 100368403

(73) Assignee: FAG Aircraft / Super precision Bearings GmbH

(21) Appl. No.: 10/013,767

(22) Filed: Dec. 11, 2001

(30) Foreign Application Priority Data
Dec. 12, 2000 (DE) 100 61 786.7

(51) Int. Cl. F16J 15/32

(52) U.S. Cl. 277/353

(57) ABSTRACT

A seal for a track roller bearing, the bearing including an outer ring an inner ring and a bearing arrangement of rolling bodies or of a sliding body between the bearing rings. A respective thrust washer at each lateral side of the outer ring and extending radially past the bearing arrangement. A circumferential groove around the periphery of the thrust washers. A respective seal between the outer ring and each thrust washer, the seal including a first axially extending leg with a shoulder in the groove in the thrust washer and including a second obliquely radially and axially outwardly extending leg terminating in a sealing lip which is received in a recess in the outer ring. An annular shoulder defines the axial outside of the recess and the inner surface of the shoulder is gap spaced from the lip enabling the oblique arm to deflect outwardly upon over pressure of the bearing.

### FIELD OF THE INVENTION

Track roller bearings are rolling or sliding bearings which are used to guide structural parts in various applications. In aviation, these track roller bearings are used to support the landing flaps, for example.

### BACKGROUND OF THE INVENTION

In the field of aviation, track roller bearings are used in extreme climatic conditions. At the same time, the high safety standards demanded of these track roller bearings in their use in airplanes must be taken into account. To satisfy the demands regarding their use in airplanes, it is imperative that the track roller bearings be very well sealed. The seal between the rotating outer ring and the thrust washer of the bearing has the objects of protecting the bearing from penetration of dirt, guaranteeing sealing even when the seal surfaces have iced over, and preventing the penetration of media, such as de-icing fluid, when the latter is sprayed on directly. However, when relubricating these bearings, it must be possible for the excess grease to escape via the seal surfaces. Airline companies also require that these track roller bearings form a nonseparable structural unit before they are fitted in the airplane and that they cannot come apart during handling and fitting. In practice, this requirement is satisfied by using additional structural parts.

German Utility Model 1888006 shows a track roller bearing which can form a structural unit. This bearing has the disadvantages that, on the one hand, for construction reasons, the seal has to be configured as a gap seal, and, on the other hand, there is a problem that in the event of internal overpressure, the two gap seals are pressed outward so that excess grease cannot escape.

German Utility Model 1935256 shows a track roller bearing which has a closed seal, but cannot form a structural unit since the thrust washers can fall out when the track roller bearing is being fitted in the airplane. A further problem with this bearing is that the sealing lip is unprotected, so that de-icing liquid which is sprayed on can pass directly under the seal lip and thus reach into the inside of the bearing.

### OBJECT OF THE INVENTION

The object of the invention is to provide a seal for a track roller bearing which produces a structural unit between the outer ring and the thrust washer and satisfies the required sealing properties.

### DESCRIPTION OF THE INVENTION

A track roller bearing has or a track bearing according to the invention includes inner and outer bearing rings and a bearing arrangement between the rings enabling relative rotation of the rings. The bearing arrangement may comprise one or more typically a plurality, of rolling bodies between the rings or a sliding body between the rings. The object is achieved with a track roller bearing having a thrust washer on one lateral side and preferably on both lateral sides and with a seal around the periphery of each thrust washer. The seal is generally V-shaped, including one arm that extends axially out over the periphery of the thrust washer and that arm having a shoulder that enters a groove in the periphery of the thrust washer. The seal includes another arm of the seal that is inclined obliquely both radially and axially outwardly, and normally engages in a groove near the axially outward side of the washer. The oblique arm is deflectable outwardly upon occurrence of overpressure in the bearing.

The seal of the invention is placed on the axial disk and then is snapped into the recess on the axially outward end of the outer ring. When the track roller bearing has been fitted, the structural unit obtained does not require additional structural parts. The sealing lip of the seal lies in the recess in the outer ring during operation. But when lubricating grease is topped up, the lip can discharge excess grease outward.

Another important advantage is that, by arranging the sealing lip in a recess of the outer ring, the sealing lip is protected by the annular shoulder on the outer ring so that no medium like a de-icing liquid can be sprayed directly on or directly under or around the sealing lip.

The seal can be used both in slide-mounted and roll-mounted track roller bearings and cam rollers.

Other aspects and features of the invention will be apparent from the bearing described below in connection with the accompanying drawings.

### BRIEF DESCRIPTION OF THE DRAWINGS

FIG. 1 shows a cross section through a track roller bearing according to the invention,

FIG. 2 shows a detail of the seal in FIG. 1,

FIG. 3 shows a track roller with a journal,

FIG. 4 shows a track roller with thrust washers integrated in the bearing inner rings, and

FIG. 5 is a cross section through an alternate embodiment of a track roller bearing.

### DESCRIPTION OF PREFERRED EMBODIMENTS

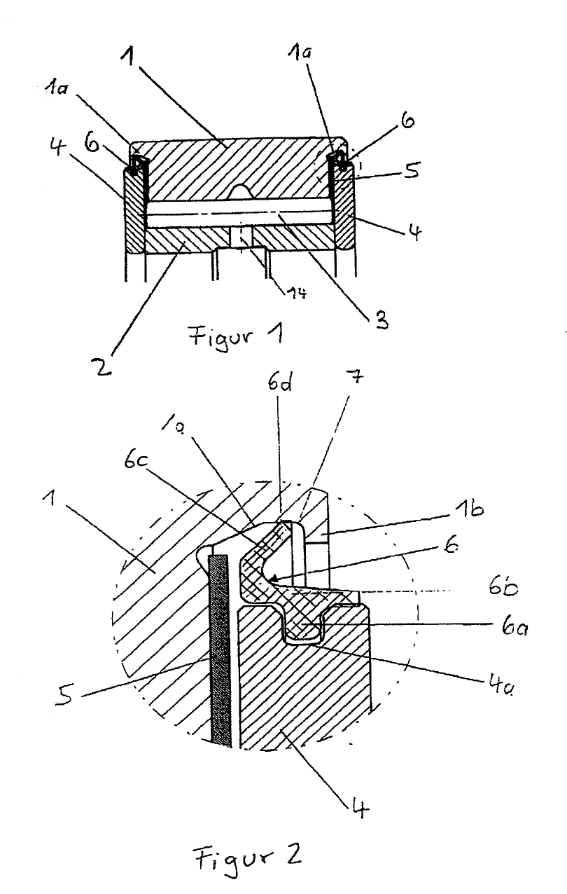

FIG. 1 illustrates a roll-mounted track roller bearing including an outer ring 1, an inner ring 2, rolling bodies 3 between the rings, a thrust washer 4 at each lateral side of the outer ring and extending past the rolling bodies and a slide washer 5 between each thrust washer 4 and the respective lateral side of the outer ring, and a seal 6 according the invention at each side. The inner ring 2 has a relubrication channel 14. Solutions with one or two rows of rolling bodies are not shown in detail in the drawings since the nature of the rolling bearing is not a feature influencing the invention.

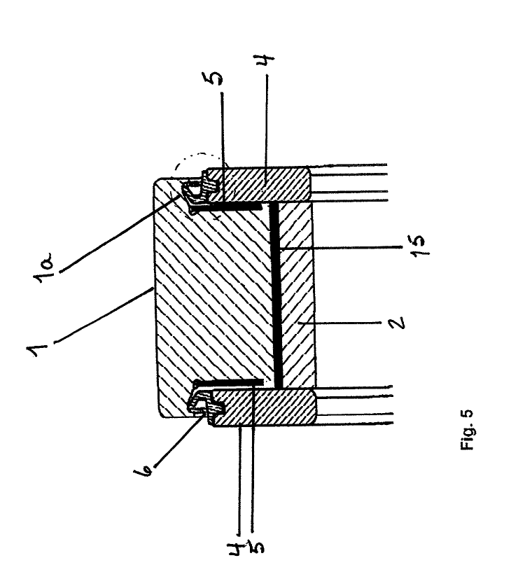

Instead of using rolling bodies 3 between the rings 1 and 2, it is also possible to use slide bodies between the bearing rings. The embodiment of FIG. 5 is essentially the same as that in FIG. 1, but without rolling bodies 3. Instead, a sliding body 15, here a sleeve of plastic material, which permits sliding between the rings and the sliding body and permits relative rotation of the rings with respect to each other, e.g. made from the material of the slide washer, is used for the sliding body disposed between the rings 1 and 2 which then slide on this body relative to each other.

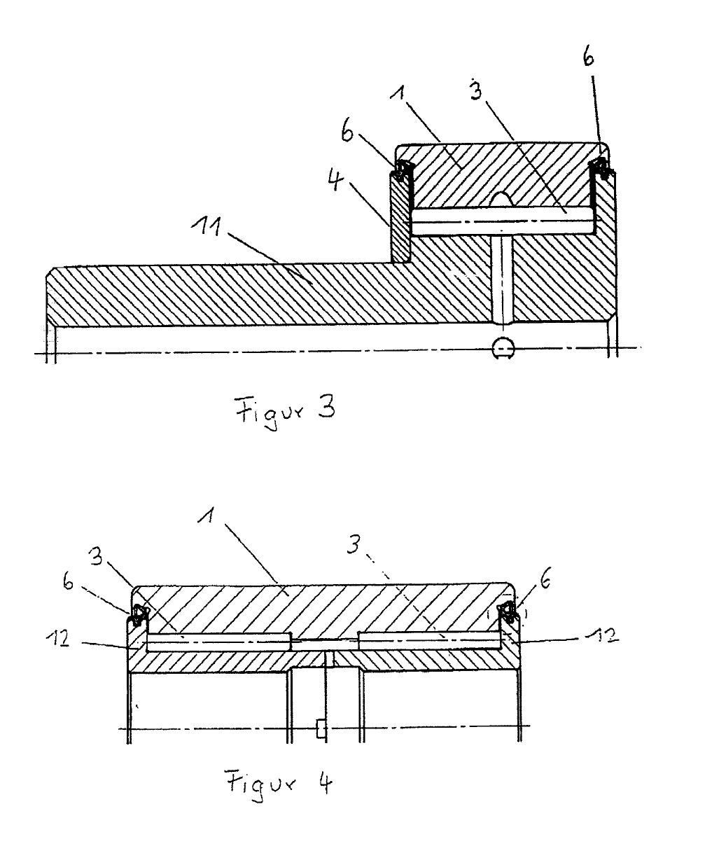

The seal 6 according to the invention is shown in a partial cross section in FIG. 2. It is a plastic component. It has a generally V-shape. One leg 6b extends axially over the periphery of the thrust washer. An annular, radially inwardly projecting shoulder 6a inside the axially outwardly extending leg 6b seal 6 engages in a circumferential groove 4a around the periphery of the thrust washer 4. In the axial direction, the seal 6 is secured with a form fit in the groove 4a. The other outer leg 6c of the seal 6 extends from the axially inward end of the leg 6b inward of the groove 4a and extends obliquely both radially and axially outward, and ends in a sealing lip 6d. The inclination of the leg 6c is chosen such that, in the event of an internal overpressure in the bearing, for example when topping up the lubricating grease, the sealing lip opens axially outwardly allowing excess grease to escape. The sealing lip 6d lies in and is held elastically in the recess 1a at the inward facing side of the axially outer edge region of the outer ring by contacting the inward facing surface defining that recess. The axially outward annular shoulder 1b on the outer ring defines the recess 1a and protects the sealing lip 6d from direct action of media, such as de-icing spray.

The axial width of the gap 7 between the sealing lip 6d and a laterally inwardly facing surface of the annular shoulder 1b on the outer ring 1 is chosen so that the seal 6 can flex and then snap easily into the recess 1a upon fitting.

A plastic material slide washer 5 extends radially between the lateral side of the outer ring 1 and the side of the thrust washer 4 in order to reduce friction between them. Such a plastic slide washer, which has no features essential to the invention, is not required. The alternative without the slide washers is not shown.

FIG. 3 shows a track roller with a journal 11. Here, a thrust washer is connected as one piece to the stay bolt or journal 11. The function of the seal elements is the same as in FIG. 2.

FIG. 4 shows a track roller including two inner rings 12 in a row and each inner ring integral with a respective thrust washer. The function of the seal is as described in FIG. 2.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A seal for a track bearing, wherein the bearing comprises
a bearing outer ring, a bearing inner ring radially inside the outer ring and a bearing arrangement between the inner and outer rings enabling the rings to rotate relative to one another over the bearing arrangement; at least the bearing outer ring and the bearing arrangement having axially opposite lateral sides;
a respective thrust washer at each lateral side of the outer ring and extending past the bearing arrangement, and the thrust washers being for axial guiding; each of the thrust washers including a periphery and a circumferential groove in and extending around the periphery;
a seal at each lateral side of the outer ring between the outer ring and the respective thrust washer, the seal including
a first leg with a form fit annular shoulder which fits into the circumferential groove in the thrust washer;
a second leg of the seal being directed obliquely radially and axially outward from an axially inward area of the thrust washer and the second leg of the seal terminating at a sealing lip;
the oblique second leg of the seal being inclined axially outwardly such that the oblique leg is deflectable outwardly upon overpressure in the bearing acting on the oblique leg;
the outer ring including a recess which opens radially inwardly, and the sealing lip extending into the recess and contacting an inward facing surface defining the recess in the outer ring.

2. The seal of claim 1, wherein the outer ring includes an annular shoulder axially outwardly of and defining the recess of the outer ring and the sealing lip being in the recess defined by the annular shoulder on the outer ring.

3. The seal of claim 1, wherein the seal has an approximately V-shape, with the second oblique leg and the first axially extending leg defining the V-shape.

4. The seal of claim 2, wherein the recess is so shaped, the shoulder defining the recess is so placed and the oblique leg is so shaped and oriented and of such length that the sealing lip of the seal in the recess lies opposite an axially inside surface of the annular shoulder on the outer ring with a gap between the sealing lip and the axially inside surface of the shoulder.

5. The seal of claim 1, wherein at least one of the thrust washers is integrated with the inner ring.

6. The seal of claim 1, further comprising a radially extending slide washer between the outer ring and the thrust washer enabling sliding between them.

7. The seal of claim 1, wherein there are two of the inner rings axially arranged, with each of the inner rings being integrated with a respective one of the thrust washers.

8. The seal of claim 1, wherein the bearing arrangement comprises a rolling body between the rings.

9. The seal of claim 1, wherein the bearing arrangement comprises a plurality of rolling bodies between the rings.

10. The seal of claim 1, wherein the bearing arrangement comprises a sliding body between and contacting the rings enabling the rings to slide with respect to the sliding body and to rotate with respect to each other.

11. A seal for a track roller bearing, wherein the bearing comprises a bearing outer ring, a bearing inner ring radially inside the outer ring and a bearing arrangement between the inner and outer rings enabling the rings to rotate relative to one another over the bearing arrangement; at least the bearing outer ring and the bearing elements having axially opposite lateral sides;
a thrust washer at at least one lateral side of the outer ring and extending past the bearing arrangement, and the thrust washer being for axial guiding; the thrust washer including a periphery and a circumferential groove in and extending around the periphery;
the seal being disposed between the outer ring and the respective thrust washer there, the seal including
a first leg with a form fit, annular shoulder which fits into the circumferential groove in the thrust washer;
a second leg of the seal being directed obliquely radially and axially outward from an axially inward area of the thrust washer at the groove and the second leg of the seal terminating at a sealing lip, the oblique leg of the seal being inclined axially outwardly such that the oblique leg is deflectable outwardly upon over pressure in the bearing acting on the oblique leg;
the outer ring including a recess which opens radially inwardly and the sealing lip extending into the recess and contacting an inward facing surface defining the recess in the outer ring.

12. The seal of claim 11, wherein the outer ring includes an annular shoulder axially outwardly of and defining the recess of the outer ring and the sealing lip being in the recess defined by the annular shoulder on the outer ring.

13. The seal of claim 12, wherein the recess is so shaped, the shoulder defining the recess is so placed and the oblique leg is so shaped and oriented and of such length that the sealing lip of the seal in the recess lies opposite an axially inside surface of the annular shoulder on the outer ring with a gap between the sealing lip and the axially inside lateral surface of the shoulder.

14. The seal of claim 11, wherein the seal has an approximately V-shape, with the second oblique leg and the first axially extending leg defining the V-shape.

15. The seal of claim 11, wherein at least one of the thrust washers is integrated with the inner ring.
